(19) United States
(12) Patent Application Publication
(10) Pub. No.: US 2024/0091923 A1
(43) Pub. Date: Mar. 21, 2024

(54) MULTI-USE HAMMER AND EXTENSION POLE

(71) Applicant: Jacob Cordova, Queen Creek, AZ (US)

(72) Inventor: Jacob Cordova, Queen Creek, AZ (US)

(21) Appl. No.: 18/237,521

(22) Filed: Aug. 24, 2023

Related U.S. Application Data
(60) Provisional application No. 63/407,645, filed on Sep. 17, 2022.

(51) Int. Cl. B25F 1/00; B25G 1/04

(52) U.S. Cl. CPC B25F 1/006; B25G 1/04

(57) ABSTRACT

A multi-use hammer and extension pole adapted to act as a hand-held striking tool including a head for striking, a claw for removing nails, a rectangular cavity for engaging and removing lag bolts, and a ring for releasably attaching to an extension pole.

### CROSS-REFERENCE TO RELATED APPLICATION

The present application is related to and claims priority from prior provisional application Ser. No. 63/407,645, filed Sep. 17, 2022 which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to multi-use hammers and extension poles used in electrical applications.

### 2. Description of the Related Art

Prior art extension poles used in electrical applications are not adapted to be used as a striking tool, nor adapted to be used to remove lag bolts from electrical poles. In use, a journeyman lineman uses an extension pole, usually called a “shotgun” or “hot stick” for working on and grounding power lines, however, they cannot strike an object or remove a lag bolt, which is necessary in many circumstances while services power lines.

Accordingly, the present invention overcomes the disadvantages associated with the prior art, by providing a an extension pole that is adapted to be used as a striking tool and lag bolt remover as well to avoid the above-mentioned problems.

### BRIEF SUMMARY OF THE INVENTION

In view of the foregoing disadvantages inherent in the known types of multi-use hammers and extension poles or the like in the prior art, the present invention provides a novel multi-use hammer and extension pole. As such, the general purpose of the present invention, which will be described subsequently in greater detail, is to provide a multi-use hammer and extension pole adapted to act as a hand-held striking tool including a head for striking, a claw for removing nails, a rectangular cavity for engaging and removing lag bolts, and a ring for releasably attaching to an extension pole with all the advantages of the prior art and none of the disadvantages.

There has thus been outlined, rather broadly, the more important features of the invention in order that the detailed description thereof that follows may be better understood and in order that the present contribution to the art may be better appreciated. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, a multi-use hammer and extension pole, constructed and operative according to the teachings of the present invention.

FIG. 1 shows a side view illustrating a multi-use hammer according to the preferred embodiment of the present invention.

FIG. 2 shows a perspective view illustrating the multi-use hammer engaging a lag bolt according to the preferred embodiment of the present invention of FIG. 1.

FIG. 3 shows a side view illustrating the multi-use hammer being engaged by an extension pole according to the preferred embodiment of the present invention of FIG. 1.

FIG. 4 shows a side view illustrating the extension pole according to the preferred embodiment of the present invention.

FIG. 5A shows a bottom view of the multi-use hammer according to the preferred embodiment of the present invention.

FIG. 5B shows a top view illustrating the extension pole according to the preferred embodiment of the present invention.

FIG. 6 shows a side view illustrating the extension pole according to the preferred embodiment of the present invention.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

As discussed above, embodiments of the present invention relate to a multi-use hammer and extension pole.

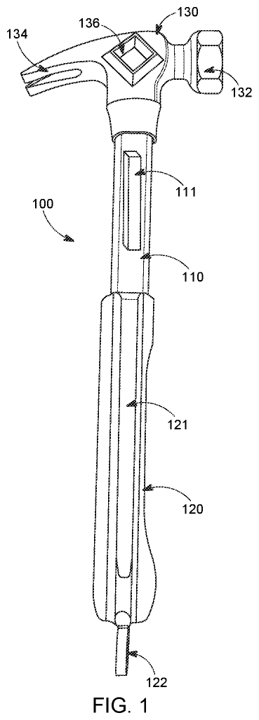

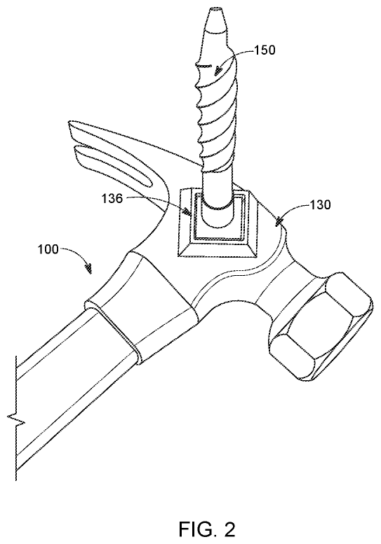

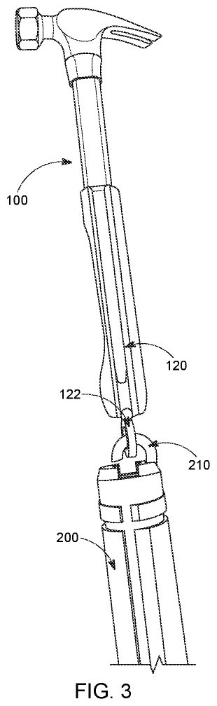

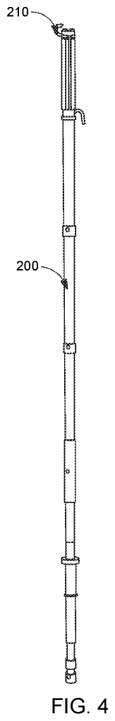

Referring now to the drawings FIGS. 1-4, the multi-use hammer 100 includes an elongated shaft 110, an elongated handle 120, an engagement ring 122 for releasably attaching to an extension pole, a head 130 having a striking portion 132, a claw 134 for removing nails, and a rectangular cavity 136 for engaging and removing lag bolts.

The extension pole 200 includes an engagement hook 210 adapted to releasably engage the engagement ring 122 of the multi-use hammer 100. The extension pole 200 further includes a mechanism therein for moving the engagement hook 210 linearly in and out of the end thereof, such that it can engage the engagement ring 122 of the multi-use hammer 100 and pull the handle 120 of the multi-use hammer 100 inside the extension pole 200 in order to secure the multi-use hammer 100 to the extension pole 200 for use. In reverse, the mechanism is further adapted to push the multi-use hammer 100 out of the extension pole 200 and disengage therefrom.

The multi-use hammer 100 may further include a square face with angled edges, and include a cavity 111 to store nails and staples therein and be held for installation. The extension pole 200 and the multi-use hammer 100 may also have interdigitating edges and/or grooves adapted to facilitate the insertion and removal of the multi-use hammer 100 within the extension pole 200.

The multi-use hammer 100 may be formed from a material including hardened steel, aluminum, fiberglass, or the like. The extension pole 200 may be formed from a material including fiberglass or the like and other materials that provide electrical insulation.

In the preferred embodiment, the elongated shaft 110 includes a proximal end, and a distal end; the elongated handle 120 includes a proximal end, and a distal end, wherein the proximal end of the elongated handle is attached to the distal end of the elongated shaft; the engagement ring 122 is attached to the distal end of the elongated handle and is adapted to releasably engage with extension pole 200; the head 130 includes the striking portion 132 adapted to strike the head of a nail, the claw 134 is adapted to engage and remove nails from a wooden pole; the rectangular cavity 136 is adapted to engage with the rectangular end portion of a lag bolt to rotate the lag bolt; wherein the head 130 is attached to the proximal end of the elongated shaft 110; and wherein said multi-use hammer 100 is adapted to drive nails into a wooden pole, remove nails from a wooden pole, and engage and rotate lag bolts to thereby insert or remove the lag bolts from a wooden pole.

The elongated shaft 110 further includes a cavity 111 to store nails and staples therein. Furthermore, the elongated handle 120 further includes spaced elongated ridges 121 thereon adapted to engage elongated grooves 201 of extension pole 200 to thereby prevent rotation of the multi-use hammer when engaged with the extension pole. Furthermore, the elongated shaft 110, the elongated handle 120, and the head 130 are formed from a material chosen from a list of materials consisting of hardened steel, aluminum, and fiberglass.

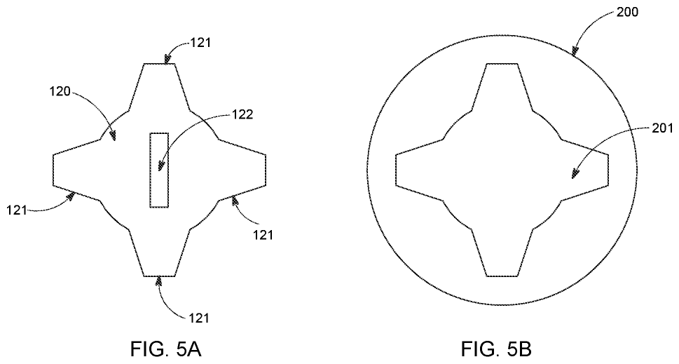

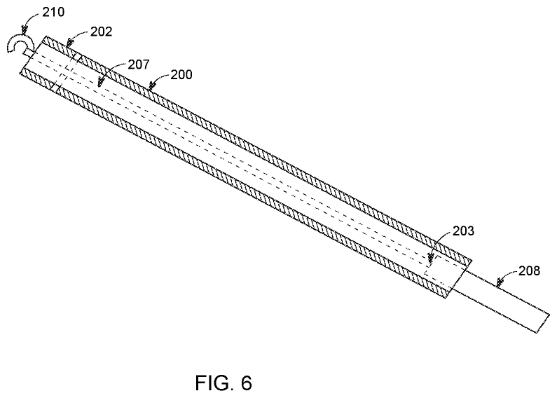

In the preferred embodiment, shown in FIGS. 5+, extension pole 200 includes a hollow interior, a proximal end, and a distal end; a handle 208 that is movably attached to the distal end thereof; an attachment portion 202 including a hollow interior, and an interior surface including a plurality of spaced elongated grooves 201, wherein the attachment portion 202 is attached to the proximal end of the extension pole and is adapted to releasably engage with spaced elongated ridges 121 of the multi-use hammer 100; and an attachment mechanism 203 including engagement hook 210 adapted to releasably engage with engagement ring 122 of the multi-use hammer 100, an elongated rod 207 located within the hollow interior of the hollow extension pole 200 and adapted to move linearly therein, and is connected between the engagement hook 210 and the handle 208, wherein the attachment mechanism 203 is adapted to releasably attach to the handle of the multi-use hammer and pull the handle within the hollow interior of the extension pole in order to secure the multi-use hammer to the extension pole for use therewith, and in reverse, the attachment mechanism is further adapted to push the multi-use hammer out from the interior of the extension pole for disengagement therefrom, such that the extension pole is adapted to manipulate the multi-use hammer when in use.

Furthermore, in the preferred embodiment, the elongated shaft of the multi-use hammer 100 includes a proximal end and a distal end; the elongated handle has a proximal end and a distal end, wherein the proximal end of the elongated handle 120 is attached to the distal end of the elongated shaft 110; spaced elongated ridges 121 thereon adapted to engage with the spaced elongated grooves 201 of the extension pole to thereby prevent rotation of the multi-use hammer when engaged with the extension pole; the engagement ring 122 is attached to the distal end of the elongated handle 120, and is adapted to releasably engage with the engagement hook 210 of the attachment mechanism 203 of the extension pole.

When in use, the handle of the extension pole is pushed toward the distal end of the extension pole thereby forcing the engagement hook outwardly from the proximal end of the extension pole; then the multi-use hammer is removably attached to the engagement hook via the engagement ring; then the handle of the extension pole is pulled away from the distal end of the extension pole thereby drawing the elongated handle of the multi-use hammer into the attachment portion of the extension pole, wherein the spaced elongated ridges of the elongated handle of the multi-use hammer interdigitatingly engage with the spaced elongated grooves of the extension pole to thereby prevent rotation of the multi-use hammer when in use; and in reverse, and after use, the handle of the extension pole is pushed toward the distal end of the extension pole thereby forcing the engagement hook and the multi-use hammer outwardly from the proximal end of the extension pole; then the multi-use hammer is removed from the engagement hook; then the handle of the extension pole is pulled away from the distal end of the extension pole thereby drawing the engagement hook back within the proximal end of the extension pole for storage thereof.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. A multi-use hammer comprising:
an elongated shaft including:
a proximal end; and
a distal end;
an elongated handle including:
a proximal end; and
a distal end;
wherein said proximal end of said elongated handle is attached to said distal end of said elongated shaft;
an engagement ring;
wherein said engagement ring is attached to said distal end of said elongated handle, and is adapted to releasably engage with an extension pole; and
a head including:
a striking portion;
wherein said striking portion is adapted to strike the head of a nail;
a claw;
wherein said claw is adapted to engage and remove nails from a wooden pole; and
a rectangular cavity;
wherein said rectangular cavity is adapted to engage with a rectangular end portion of a lag bolt to rotate said lag bolt;
wherein said head is attached to said proximal end of said elongated shaft;
wherein said multi-use hammer is adapted to drive nails into a wooden pole;
remove nails from a wooden pole; and engage and rotate lag bolts to thereby insert or remove said lag bolts from a wooden pole.

2. The multi-use hammer of claim 1, wherein said elongated shaft further includes a cavity to store nails and staples therein.

3. The multi-use hammer of claim 1, wherein said handle further includes spaced elongated ridges thereon adapted to engage elongated grooves of an extension pole to thereby prevent rotation of said multi-use hammer when engaged with said extension pole.

4. The multi-use hammer of claim 1, wherein said elongated shaft, said elongated handle, and said head are formed from a material chosen from a list of materials consisting of hardened steel, aluminum, and fiberglass.

5. A combination of a multi-use hammer and extension pole comprising:
an extension pole comprising:
a hollow interior;
a proximal end; and
a distal end;
a handle;
wherein said handle is movably attached to said distal end of said extension pole;
an attachment portion including:
a hollow interior;
an interior surface including:
a plurality of spaced elongated grooves;
wherein said attachment portion is attached to said proximal end of said extension pole and is adapted to releasably engage with a multi-use hammer; and
an attachment mechanism including:
engagement hook;
wherein said engagement hook is adapted to releasably engage an engagement ring of said multi-use hammer;
an elongated rod;
wherein said elongated rod is located within said hollow interior of said hollow extension pole and adapted to move linearly therein, and is connected between said engagement hook and said handle;
wherein said attachment mechanism is adapted to releasably attach to a handle of said multi-use hammer and pull said handle within said hollow interior of said extension pole in order to secure said multi-use hammer to said extension pole for use therewith, and in reverse, said attachment mechanism is further adapted to push said multi-use hammer out from said interior of said extension pole for disengagement therefrom;
wherein said extension pole is adapted to manipulate said multi-use hammer when in use; and
a multi-use hammer comprising:
an elongated shaft including:
a proximal end; and
a distal end;
an elongated handle including:
a proximal end; and
a distal end;
wherein said proximal end of said elongated handle is attached to said distal end of said elongated shaft;
spaced elongated ridges thereon adapted to engage with said spaced elongated grooves of said extension pole to thereby prevent rotation of said multi-use hammer when engaged with said extension pole;
an engagement ring;
wherein said engagement ring is attached to said distal end of said elongated handle, and is adapted to releasably engage with said engagement hook of said attachment mechanism of said extension pole; and
a head including:
a striking portion;
wherein said striking portion is adapted to strike the head of a nail;
a claw;
wherein said claw is adapted to engage and remove nails from a wooden pole; and
a rectangular cavity;
wherein said rectangular cavity is adapted to engage with a rectangular end portion of a lag bolt to rotate said lag bolt;
wherein said head is attached to said proximal end of said elongated shaft;
wherein said multi-use hammer is adapted to drive nails into a wooden pole;
remove nails from a wooden pole; and engage and rotate lag bolts to thereby insert or remove said lag bolts from a wooden pole;
wherein when in use, said handle of said extension pole is pushed toward said distal end of said extension pole thereby forcing said engagement hook outwardly from said proximal end of said extension pole; then said multi-use hammer is removably attached to said engagement hook via said engagement ring; then said handle of said extension pole is pulled away from said distal end of said extension pole thereby drawing said elongated handle of said multi-use hammer into said attachment portion of said extension pole, wherein said spaced elongated ridges of said elongated handle of said multi-use hammer interdigitatingly engage with said spaced elongated grooves of said extension pole to thereby prevent rotation of said multi-use hammer when in use; and in reverse, and after use, said handle of said extension pole is pushed toward said distal end of said extension pole thereby forcing said engagement hook and said multi-use hammer outwardly from said proximal end of said extension pole; then said multi-use hammer is removed from said engagement hook; then said handle of said extension pole is pulled away from said distal end of said extension pole thereby drawing said engagement hook back within said proximal end of said extension pole for storage thereof.

6. The combination of claim 5, wherein said elongated shaft further includes a cavity to store nails and staples therein.

7. The combination of claim 5, wherein said elongated shaft, said elongated handle, and said head of said multi-use hammer are formed from a material chosen from a list of materials consisting of hardened steel, aluminum, and fiberglass.
